(19) United States
(12) Patent Application Publication
(10) Pub. No.: US 2020/0156058 A1
(43) Pub. Date: May 21, 2020

(54) SAMPLE RESERVOIR INSERTS AND METHODS FOR USE IN SEPARATING CELLS FROM A BIOLOGICAL TISSUE SPECIMEN

(71) Applicant: Maria Kleppe, New York, NY (US)

(72) Inventor: Maria Kleppe, New York, NY (US)

(21) Appl. No.: 16/656,216

(22) Filed: Oct. 17, 2019

Related U.S. Application Data
(60) Provisional application No. 62/748,109, filed on Oct. 19, 2018.

(51) Int. Cl. B01L 3/00; B04B 5/04

(52) U.S. Cl. CPC B01L 3/5021; B04B 5/0414; B01L 2400/0409; B01L 2300/0618; B01L 2300/0832; B04B 2005/0435

(57) ABSTRACT

Embodiments described herein include sample reservoir insert devices and methods of using and making the same. The embodiments can be used for the separation of bone marrow cells from murine and human specimens by centrifugal force. The devices can be sterile, single use rigid embodiments with an attached cap coupled to the sample reservoir insert with a hinge within which the specimens will be placed during the separation procedure.

### CROSS-REFERENCE TO RELATED APPLICATIONS

The present application claims priority to U.S. provisional patent application 62/748,109, filed Oct. 19, 2018, and entitled “Sample Reservoir Inserts And Methods For Use In Separating Cells From A Biological Tissue Specimen,” the contents of which are incorporated by reference herein in their entirety.

### FIELD OF THE DISCLOSURE

The present invention relates to sample reservoir inserts and methods of using the inserts for separating cells and cellular components from tissue components, and in particular for separating bone marrow cells from bones with a spin-column based systems.

### BACKGROUND

Sampling of the cellular composition of bone marrow is a routine procedure in both the research and clinical setting. The bone marrow is the site of hematopoiesis and contains largely heterogeneous and functionally distinct subpopulations of blood cells including erythrocytes, granulocytes, monocytes, dendritic cells, lymphocytes and hematopoietic stem cells.

For separation of bone marrow cells from mice in a laboratory setting, different type of bones may be harvested. Leg long bones (tibia, femur and hip) are the most convenient and commonly used for bone marrow separation. The yield of bone marrow cells from bone with the same cellularity may vary significantly if different methods for cell separation are used. Similar difficulties are encountered when separating bone marrow cells from human biopsy samples of bone marrow.

Bone marrow cells are sensitive to a number of external factors and therefore it is vitally important that any separation procedure is done as rapidly as possible in order to avoid unnecessary manipulations of the cells. Hence, simplified, stepwise, defined and standardized methods, which also allow simultaneous processing of samples, are required for the separation of bone marrow cells from mice.

Unfortunately, currently available bone marrow separation methods require multiple steps, result in highly variable yield, are prone to contamination, wasteful, may not allow for parallel sample processing, and may be too slow for time-sensitive applications. Accordingly, standardized, faster, higher-throughput, and/or more economic separation methods are needed particularly for use in time-sensitive applications and large sample numbers.

### SUMMARY OF THE INVENTION

Provided are devices and methods of separating cells from bones and can comprise centrifuging a sample reservoir insert containing a bone sample cut at both ends, wherein the sample reservoir insert is disposed within a collection reservoir. During centrifugation, bone marrow cells are flushed out of the bone sample and the flushed cells pass through outflow openings at the bottom of the sample reservoir insert and into the collection reservoir. Embodiments described herein facilitate removal of cellular components from a bone cavity or skeletal biopsy cores while reducing the risk of damage to cellular components and the likelihood of contamination of the sample with non-hematopoietic cell components.

One aspect of the present disclosure is a single-well sample reservoir insert, such as a single-well centrifuge vial insert. The single-well sample reservoir insert comprises a sidewall defining a chamber and having a first end and a second end, the first end being open and configured to couple to a cap and the second end being generally closed and comprising a plurality of openings. The openings can be sized to allow cells or cellular components and exclude tissue components, such as bone tissue of a bone sample. The second end is also sized for insertion into a collection reservoir, such as a centrifuge vial. The sample reservoir insert can comprise a structural member where at least a portion of the member couples to the sidewall into the chamber. The structural member can be integral with the vial insert or insertable into the chamber of the vial insert. The structural member can be configured to support a biological sample when disposed within the chamber so that the sample is in a more upright position than it would be otherwise, e.g., so that at least one end of it does not contact the side wall of the sample reservoir insert.

Another aspect of the present disclosure is a multi-well sample reservoir insert, such as a multi-well centrifuge vial insert. The insert comprising a plurality of wells and configured such that the plurality of wells can be inserted together into a collection reservoir, such as a centrifuge vial or other collection vessel, each well comprises a sidewall defining a chamber and has a first end and a second end. The first end is open and the second end is generally closed and comprising a plurality of openings. The openings can be sized to allow intact cells to pass therethrough. Each well can comprise a structural member where at least a portion of the member projects from the sidewall into the chamber. The structural member can be configured to support a biological sample when disposed within the chamber in a more upright position than the sample would be otherwise.

Yet another aspect of the present disclosure is a method of separating cells from a biological specimen using a single-well or multi-well sample reservoir insert. The method can comprise placing the biological sample into a well of a sample reservoir insert; placing the sample reservoir insert into a collection reservoir, such as a centrifuge vial; and flushing cells from the biological specimen through the openings such that the cells are collected in the collection reservoir.

Other embodiments can comprise a bone marrow extraction kit. The kit may contain the following reagents/items: (a) collection reservoir(s), such as centrifuge vial(s); (b) sample reservoir insert(s); (c) sterile ammonium-chloride-potassium lysing buffer, (d) sterile phosphate buffer saline solution, and (e) sterile cell strainers.

### BRIEF DESCRIPTION OF FIGURES

The drawings illustrate only example embodiments of a sample reservoir and sample reservoir-collection reservoir assembly, and are therefore not to be considered limiting of its scope.

FIG. 1A is a perspective view of a multi-well vial insert embodiment in accordance with the present disclosure.

FIG. 1B is a top view of the embodiment shown in FIG. 1A.

FIG. 1C is a cross-sectional view taken along line A-A in FIG. 1B.

FIG. 2A is a perspective view of a single-well vial insert embodiment in accordance with the present disclosure.

FIG. 2B is a top view of the embodiment shown in FIG. 2A.

FIG. 2C is a cross-sectional view taken along line A-A in FIG. 2B.

FIG. 3A is a cross-sectional view of an embodiment comprising a vial insert disposed within a centrifuge vial in accordance with the present disclosure

FIG. 3B is a close-up view of the embodiment shown in FIG. 3A.

FIG. 3C is a close-up view of an alternate embodiment from that shown in FIG. 3B.

FIG. 4A is a side view of a vial insert embodiment in accordance with the present disclosure.

FIG. 4B is a side view of a vial insert embodiment in accordance with the present disclosure.

FIG. 5A is a side view of a schematic of a vial insert and a cutter in accordance with the present disclosure.

FIG. 5B is a top view of the schematic of that shown in FIG. 5A.

### DETAILED DESCRIPTION OF THE INVENTION

Provided are methods and devices for the separation or isolation of cells from biological specimens. The biological specimens can be any biological tissue(s), such as animal tissue(s), of which separation of smaller components from larger components is desired. For example, in some embodiments, the biological specimen is a mammalian bone sample and separation of bone marrow cells from skeletal tissue is desired. In some embodiments, the biological sample can be a murine bone or primate (e.g., human) bone, such as a skeletal biopsy sample.

Devices described herein include a single-well and a multi-well sample reservoir insert. A sample reservoir insert is configured such that at least a portion of it can be disposed within a collection reservoir. An embodiment of a collection reservoir described herein is a centrifuge vial and the sample reservoir insert is a centrifuge vial insert. Notwithstanding, it is understood that a collection reservoir can be any type of vessel and that a sample reservoir insert is a vessel configured such that at least a portion of it can be disposed within the collection reservoir.

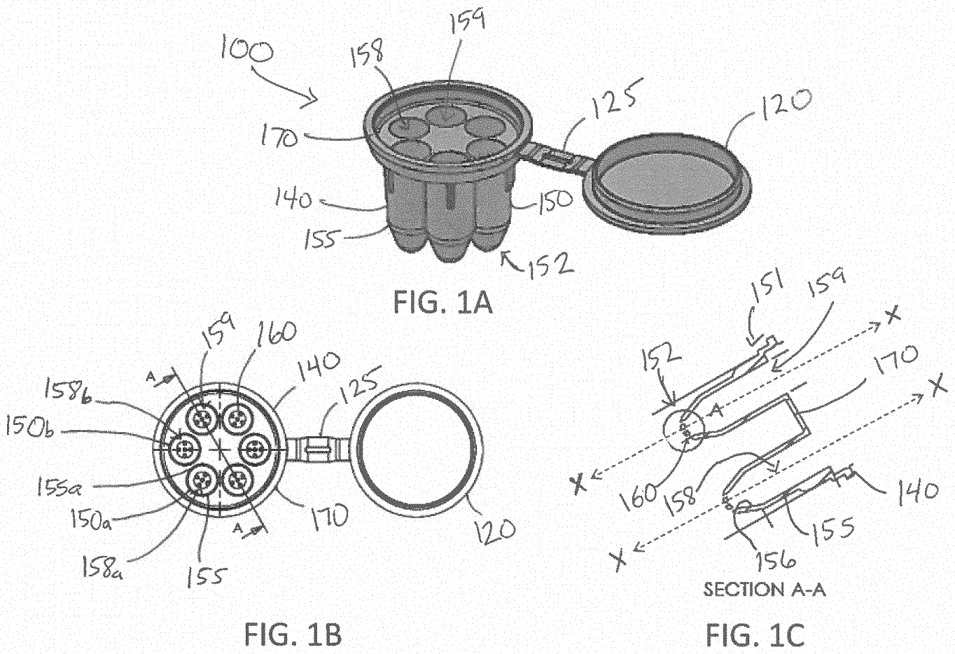

FIGS. 1A to 1C show an embodiment of a multi-well sample reservoir insert, namely, a multi-well centrifuge vial insert 100, in accordance with the present disclosure. The centrifuge vial insert 100 comprises a cap 120 and a vial insert base 140. The cap 120 is configured to couple to the vial insert base 140. The vial insert base 140 comprises a plurality of wells 150. Each well 150 comprises a sidewall 155 defining a chamber 158, and each well 150 has a first end 151 opposite a second end 152 where the first end 151 is open and the second end 152 is generally closed but for a plurality of openings 160. The vial insert 150 comprises an upper structural member 170 that defines the first end openings 159 to the wells 150. The vial insert base 140 is configured such that the second ends 152 of the plurality of wells 150 can be inserted together into a centrifuge vial. In the illustrated embodiment, a well axis X-X extends between the first end 151 and the second end 152 of each well 150, and the wells 150 are arranged such that the well axes X-X are parallel.

The cap 120 is configured to couple to the vial insert base 140, e.g., to the upper member 170, such that all first end openings 151 are covered by the cap 120. A cap 120 can couple to the vial insert base 140 in any number of mechanisms. The cap 120 can couple to the vial insert base 140 with threaded or snap-fit configuration. The cap 120 can be attached to the vial insert base 140 by a hinge 125.

In the illustrated embodiment, a portion 155a of the sidewall 155 of a first well 150a is also a portion of the sidewall 155 of a second well 150b that neighbors the first well 150a. Stated another way, one side of the sidewall portion 155a faces a first chamber 158a of the first well 150a and the opposite side of the sidewall portion 155a faces a second chamber 158b of the second well 150b.

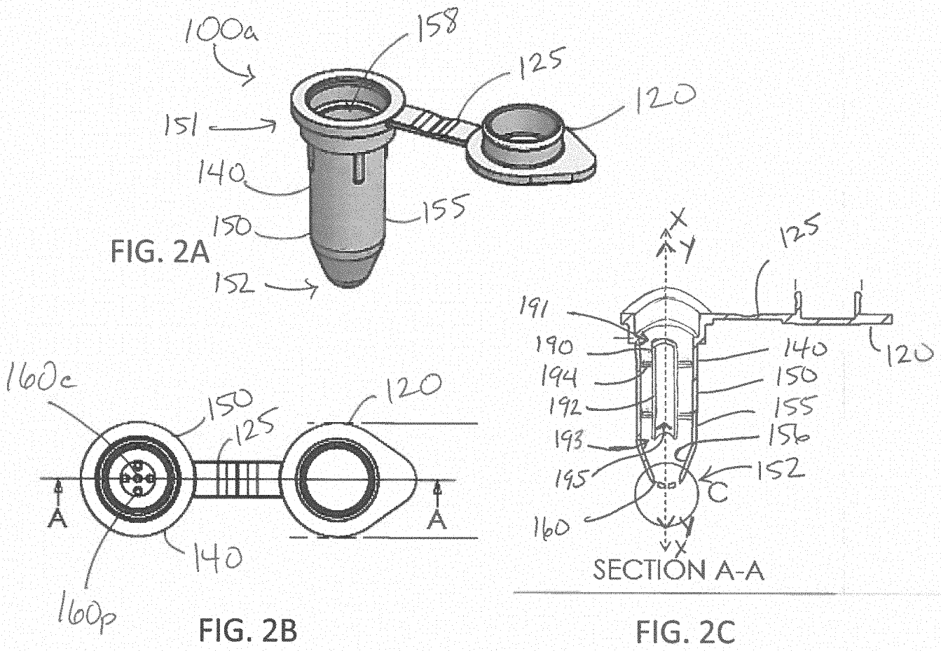

FIGS. 2A to 2C show an embodiment of a single-well sample reservoir insert, namely, a centrifuge vial insert 100a, in accordance with the present disclosure. The centrifuge vial insert 100a is similar to centrifuge vial insert 100 shown in FIGS. 1A to 1C except insert 100a has only one well. The centrifuge vial insert 100a can comprise a cap 120 and a vial insert base 140 comprising a sidewall 155 defining a chamber 158 and having a first end 151 and a second end 152 opposite the first end 151. The first end 151 is open and configured to be covered by the cap 120. A cap 120 can couple to the vial inset base 140 in any number of mechanisms. The cap 120 can couple to the vial insert base 140 with threaded or snap-fit configuration. The cap 120 can be attached to the vial insert base 140 by a hinge 125.

In both the depicted embodiments of FIGS. 1A to 1C and 2A to 2C, the second end 152 is closed except for a plurality of openings 160 that are sized to exclude larger particles yet allow smaller particles to pass through. In the case of using with biological samples, the openings 160 can be sized and shaped to allow cells or cellular components and exclude tissue components. For example, in some embodiments, the openings 160 are 0.2 to 0.8 mm in width, such as 0.2 to 0.6 mm, 0.5 to 0.7 mm, 0.6 to 0.8 mm, or any range or value therebetween. In some embodiments, the shape of the openings 160 is a rounded shape, such as a circle or oval. The number of openings 160 can vary and can be arranged in any number of patterns. The number of openings can be, for example, 1, 2, 3, 4, 5, 6, 7, 8, 9, or 10. In the illustrated embodiments, see, e.g., FIG. 2B, five openings 160 are present and arranged so that one hole 160c is at the bottommost center of the second end 102 and a plurality of openings 160p are positioned around the center hole 160c.

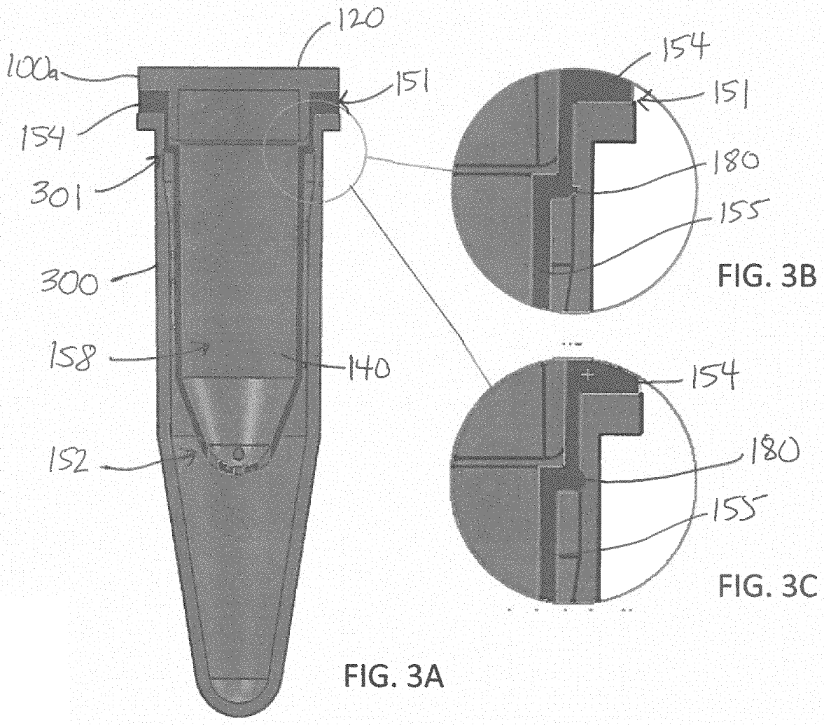

The vial insert 100, 100a in the illustrated embodiments are configured such that a portion of it is able to be inserted into a centrifuge vial. FIG. 3A illustrates a vial insert 100a configured as such and disposed within a centrifuge vial 300. Specifically, the illustrated embodiment comprises a second end 152 that is sized for insertion into a mouth 301 of a centrifuge vial 300 and a first end 151 that is sized so as not to fit into the mouth 301 of the collection reservoir, specifically centrifuge vial 300. In the embodiment shown, the first end 151 comprises a flange 154 and the transverse cross-sectional width of the flange 154 is larger than that of the mouth 301 of the centrifuge vial 300. Flange 154 or any radially projecting structural member coupled to the outer surface of the vial insert 100a nearer the first end 151 than the second end 152 can be used to prevent the first end 151 from being inserted into a collection reservoir. The vial insert 100 depicted in FIG. 1A and comprising a plurality of wells 150 is similarly configured for insertion into a collection reservoir, such as a centrifuge vial, at a second end 152 and sized at the upper structural member 170 so an not to be inserted entirely into the mouth of the collection reservoir. In some embodiments, the collection reservoir is a 50 mL centrifuge tube.

To avoid an inadvertent separation of a sample reservoir insert, such as vial inserts 100, 100a from a collection reservoir, such as centrifuge vial 300, sample reservoir insert can further be configured to securely couple with the collection reservoir. For example, a depicted in FIGS. 3A to 3C, the vial insert 100a can comprise circumferential rib 180 configured for an interference fit with the centrifuge vial 300. The circumferential rib 180 can have an angled surface (as depicted in FIG. 3B) or a curved surface (as depicted in FIG. 3C). Vial insert 100 can also comprise a circumferential rib 180 configured for an interference fit with a centrifuge vial 300 or other collection reservoir. Other options for coupling the vial insert 100, 100a with a collection reservoir, such as centrifuge vial 300, include a snap-fit configuration or a threaded configuration.

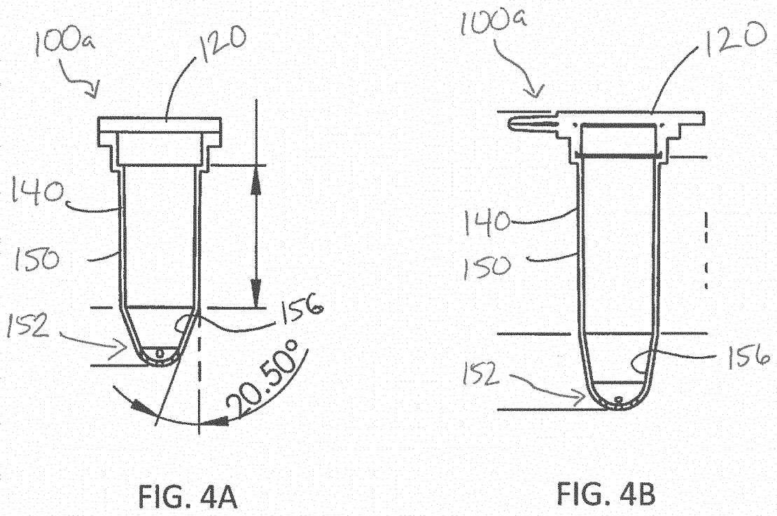

In both the depicted embodiments of FIGS. 1A to 1C and 2A to 2C, the vial insert 100, 100a is configured such that the matter intended for separation is funneled toward the openings at the second end 152 when a liquid is present or added to a well 150. For example, at least a portion of the well 150 can taper toward the second end 152, and in particular, at least a portion of the inner surface 156 of the sidewall 155 can taper toward the second end 152. In the embodiment shown, less than a third of the length of the well 150 has a tapering inner surface. As shown in FIGS. 4A and 4B, the degree of taper can vary. FIG. 4A depicts a well 150 with a higher degree of taper toward the second end of the well as compared to the embodiment depicted in FIG. 4B. The degree of taper can be between 10 to 45 degrees relative to the longitudinal axis (X-X axis), such as 10 to 25 degrees, 15 to 25 degrees, 20 to 30 degrees, or 30 to 45 degrees.

In some embodiments, a biological specimen is placed into the centrifuge vial insert for the purpose of extracting cells or cellular components from the specimen and flushing the cells or cellular components through the openings of a well and into a centrifuge vial or other collection reservoir. As depicted in embodiment of FIGS. 2A to 2C, to facilitate positioning the biological specimen within the chamber 158, each well 150 can comprise a structural member 190 configured to support an elongated biological specimen in a more upright position when disposed within the chamber 158 than it otherwise would be. For example, if a straight segment of femur bone is placed in a well 150, the structural member 190 will assist in supporting femur bone such that the end of the bone nearest the cap 120 does not contact the sidewall 155. In some embodiments, at least a portion of the structural member 190 projects from the sidewall 155 into the chamber 158.

In some embodiments, the structural member 190 comprises a sleeve 192 that has a longitudinal axis Y-Y that is generally aligned or coterminous with a longitudinal axis X-X of the well 150. The sleeve 192 is spaced apart from the sidewall 155. The sleeve 192 can be positioned in the chamber 158 such that its second end 193 (which is opposite its first end 191) is nearer the well's second end 152 than the well's first end 151. In some embodiments, the sleeve 192 comprises an interior space 195 extending between a sleeve's first end 191 and a sleeve's second end 193, and the interior space 195 of the sleeve 192 is in fluid communication with the chamber 158 at both the sleeve first end 191 and the sleeve second end 193. In some embodiments, the sleeve's second end 193 is spaced apart from the well's second end 152 to facilitate flushing of the specimen. In some embodiments (not shown), the sleeve 190 can taper toward the sleeve second end 193 much like the taper of the well 150.

One or more struts 194 projecting from the sleeve 192 can couple with the sidewall 155 to support the sleeve. For example, in some embodiment, the sleeve 192 and struts 194 are integral with the vial insert. In other embodiments, the sleeve 192 and struts 194 are a separate component that is insertable into the well 150 and the struts can be configured to couple with the sidewall 155. For example, the sidewall 155 can comprise at least two rails that extend between the first end 151 and the second end 152 of the well 150, are located opposite each other, and configured such that struts 194 coupled to the sleeve can be inserted into the rails to couple the sleeve 192 to the well 150.

A well 150 can be sized to suit the intended use. In some embodiments, a well 150 can have a maximum transverse dimension of 5 mm to 20 mm or a maximum transverse dimension that is larger than the width of a biological specimen but smaller than the specimen's length. A well can have a length that is greater than the length of the biological specimen but less than the collection reservoir length so that there is sufficient space to contain the biological specimen but allow for sufficient space between the second end of the well 150 and the base of the collection reservoir where the extract solution can collect. In some embodiments, a well 150 can be 5 to 40 mm in length, e.g., 5 to 10 mm, 10 to 15 mm, 15 to 20 mm, 20 to 30 mm, 20 to 35 mm, 30 to 35 mm, or 35 to 40 mm in length. In some embodiments, a well 150 comprises a volume of 600 to 900 μl.

A mouse bone specimen after being cut at both ends can be about 15 mm in length. In a specific embodiment of a vial insert 100a for use in separating bone marrow cells from a mouse bone specimen or similarly sized specimen, the length of the well 150 can be 20 mm to 28 mm in length, the maximum width can be 8 to 10 mm, the volume can be 600 to 900 and the well can have a portion with 20 to 22 degrees of taper toward the second end 152.

A vial insert 100, 100a can be composed of any suitable chemical resistant polymeric material or glass. The vial insert 100, 100a can be opaque or tinted to mitigate light interacting with the sample disposed therein. Polymeric materials can be, for example, a polypropylene, polyvinylchloride, high density polyethylene, polyethylene terephthalate, polytetrafluoroethylene, polyether ether ketone, or polyphenylene sulfide.

Another aspect of the disclosure is a kit comprising a centrifuge vial and a vial insert as described herein and configured for insertion into the centrifuge vial.

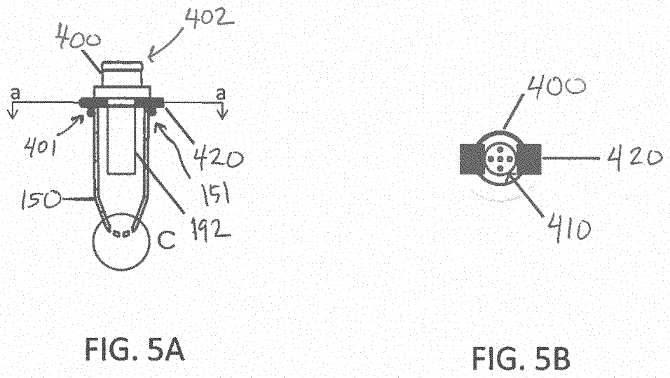

Another embodiment of the present disclosure is shown in FIGS. 5A and 5B depicting an embodiment that couples with a cutter 400 configured to cut a specimen as it passes through the cutter and into the well 150. The cutter can be configured to couple with the vial insert at a first end 401 and configured to couple with a Jamshidi needle (not shown) at a second end 402. At the first end 151 of vial insert 150, threads can engage the cutter 400 having corresponding threads at a first end 401. The second end 402 of the cutter 400 can also be threaded to engage the threaded collar of a Jamshidi needle. The cutter 400 comprises a central opening 410 that allows a bone specimen to pass through the cutter and into the well 150 of the vial insert when cutter 400 is threaded onto the vial insert. The cutter can comprise a retractable blade 420 that is configured to move across the central opening 410 to cut a specimen and then retract to its original position adjacent to the central opening 410. With this embodiment, a core sample from a Jamshidi needle can be cut as the core sample is pushed into the sleeve 192 disposed within well 150 of a vial insert 100.

Another embodiment of the present disclosure is a kit comprising at least one vial insert and a cutter as described above and shown in FIGS. 5A and 5B. The kit can further comprise a Jamshidi needle.

Another embodiment of the present disclosure comprises a method for separating cells from a biological specimen using the above described embodiments. The method can comprise placing the biological specimen into the well of a vial insert as described above; placing the vial insert into a collection reservoir, such as a centrifuge vial; and adding to the well a sterile saline buffer; centrifuging the centrifuge vial with vial insert thereby causing cells from the biological specimen to pass through the openings at the base (second end of the well) such that the cells are collected in the collection reservoir. In some embodiments, the sterile saline buffer is added to the well of the vial insert or the collection reservoir prior to placing the specimen into the vial insert. In further embodiments, flushing comprises centrifuging the sample to facilitate the cells passing through the openings. In embodiments, the method can comprise centrifuging the collection reservoir and removing liquid such that cells are concentrated at the bottom of the collection reservoir.

In some embodiments, the relative centrifugal force can be 4,000 g to 8,000 g for 1 to 4 minutes. In some embodiments, the relative centrifugal force can be 6,000 g at 2 minutes or 4,500 g for 5 minutes.

The buffer used can depend on the type of biological specimen. In embodiments, the buffer is an isotonic solution configured to protect the cells from damage during the separation process. In embodiments, the buffer is a phosphate buffer.

In various embodiments, the biological specimen comprises bone and the bone can be cut to expose bone marrow located therein. More specifically, the bone can be cut at each end of the specimen. In addition, a substantial portion of muscle and/or connective tissue can be removed from the bone portion of the specimen prior to placing in the vial insert. In some embodiments, the biological specimens are of human or mouse origin.

Another embodiment of the present disclosure comprises a method for separating bone marrow from one or more harvested bone or biopsied specimens using a sample reservoir insert, such as vial insert 100, 100a described above, can comprise the following steps: (a) inserting a sample reservoir insert into a collection reservoir, e.g., a centrifuge vial; (b) adding a sterile saline buffer (e.g., a phosphate buffer) to the vial insert or centrifuge vial; (c) preparing a specimen such as by cutting bone at each end to expose the bone marrow at each end; (d) placing the prepared specimen into the vial insert, which can comprise placing the specimen into the vial insert so that it is supported by the structural member, such as by inserting the specimen into a sleeve as described herein; (e) placing the cap on the sample reservoir insert to maintain sterility during centrifugation; (f) spinning the sample in a centrifuge to cause cells to pass through the openings and into the centrifuge vial; and (g) removing the pellet of cells at the bottom of the centrifuge vial. In some embodiments, the relative centrifugal force can be 4,000 g to 8,000 g for 1 to 4 minutes. In some embodiments, the relative centrifugal force can be 6,000 g at 2 minutes or 4,500 g for 5 minutes. In some embodiments, the method comprises adding cell lysis buffer to the centrifuge vial to suspend collected cells. In some embodiments, red blood cells can be removed by incubating the collected cells.

A method of making a vial insert, such as those described herein can comprise injecting a polymeric material into a mold defining the shape of a vial insert. The vial insert and the sleeve can be formed separately.

### EXAMPLE

The following example is meant to be illustrative and not limiting.

A vial insert (I) has a well with a cylindrical shape (length: 25 cm, width: 20 mm) and 21 degrees of taper toward the second end of the well. An integrated supporting sleeve of a cylindrical shape (diameter: 5 mm, length: 1.5 cm) can be located in the well. The insert (I) has a flange circumscribing the first end with an outer diameter of 10 mm to prevent the insert from falling into the centrifuge vial during high-speed centrifugation. The vial insert (I) also has a circumscribing rib below the flange, which allows for an interference fit with the centrifuge vial. The second end of the well has 5 circular openings, wherein 1 opening is at the bottom center and 4 openings are around the central opening. Each opening has a diameter of 0.65 mm. The sidewall of the vial insert is 1 mm thick and the well holds a volume of approximately 700 μl. A cap is coupled to the first end via a hinge. The cap has also a frosted surface to facilitate labeling the vial.

To isolate total bone marrow from biological bone specimen using vial insert (I), the following steps can be performed: (a) The vial insert (I) is placed securely into a 1.5 ml or 2 ml microcentrifuge tube; (b) 100 μl ml of sterile phosphate saline buffer is pipetted into the vial insert or microcentrifuge tube (I); (c) the bone specimens are cut open at each end and placed into the vial insert (I) and into the sleeve if present; (d) the cap is closed on the vial insert (I); (e) the vial insert (I)-microcentrifuge vial assembly is then spun with a relative centrifugal force of 6,000 g for 2 minutes; (f) the vial insert (I) containing the empty bones is separated from the microcentrifuge vial, and the total bone marrow cells can be found in form of a firm pellet at the bottom of the vial.

1. A centrifuge vial insert comprising:
a cap and
a vial comprising a sidewall defining a chamber and having a first end and a second end,
the first end being open and configured to couple to the cap,
the second end being generally closed and comprising a plurality of openings, and
the second end sized for insertion into a centrifuge vial,
wherein a structural member at least a portion of which couples to the sidewall into the chamber,
the structural member being configured to hold a biological sample when disposed within the chamber in a more upright position.

2. The centrifuge vial insert of claim 1, wherein the first end is sized so it cannot be inserted into a centrifuge vial.

3. The centrifuge vial insert of claim 2, wherein the first end comprises a flange.

4. (canceled)

5. The centrifuge vial insert of claim 1, wherein at least a portion of the vial tapers toward the second end.

6. The centrifuge vial insert of claim 1, wherein the structural member comprises a sleeve that has a longitudinal axis that is generally aligned with a longitudinal axis of the vial.

7. The centrifuge vial insert of claim 6, wherein the sleeve has a first end and a second end, wherein the sleeve second end is nearer the vial second end than the vial first end.

8. The centrifuge vial insert of claim 7, wherein the sleeve tapers toward the sleeve second end.

9. The centrifuge vial insert of claim 7, wherein the sleeve second end is spaced apart from the vial second end.

10. The centrifuge vial insert of claim 7, wherein the sleeve comprises an interior space extending between the sleeve first end and the sleeve second end, wherein the interior space is in fluid communication with the chamber at both the sleeve first end and the sleeve second end.

11. A centrifuge vial insert comprising:
a cap and a base;
the cap configured to couple to the base, and
the base comprising a plurality of wells and configured such that the plurality of wells can be inserted together into a centrifuge vial,
each well comprising a sidewall defining a chamber and having a first end and a second end, and
the first end being open and the second end being generally closed but comprising a plurality of holes that are sized to allow intact cells to pass therethrough.

12. The centrifuge vial insert of claim 11, wherein a structural member projects from the sidewall into the chamber and is configured to hold a biological sample when disposed within the chamber in a more upright position.

13. The centrifuge vial insert of claim 12, wherein the structural member comprises a sleeve that has a longitudinal axis that is generally aligned with a longitudinal axis of the base and wherein the sleeve has a first end and a second end, wherein the sleeve second end is nearer the base second end than the base first end.

14. (canceled)

15. The centrifuge vial insert of claim 14, wherein the sleeve tapers toward the sleeve second end and wherein the sleeve second end is spaced apart from the base second end and wherein the sleeve comprises an interior space extending between the sleeve first end and the sleeve second end, wherein the interior space is in fluid communication with the chamber at both the sleeve first end and the sleeve second end.

16. (canceled)

17. (canceled)

18. (canceled)

19. The centrifuge vial insert of claim 11, wherein at least a portion of each well tapers toward the second end.

20. (canceled)

21. The centrifuge vial insert of claim 11, wherein the cap is configured to couple to the base such that all the first end openings are covered by the cap.

22. The centrifuge vial insert of claim 11, a well axis extends between the first end and the second end of each well and the wells are arranged such that the well axes are parallel.

23. The centrifuge vial insert of claim 11, wherein the base is coupled to a flange that is configured so that it cannot be inserted into the centrifuge vial.

24. A method of separating cells from a biological specimen, the method comprising placing the biological sample into a centrifuge vial insert of claim 1; placing the centrifuge vial insert into a centrifuge vial; adding an adequate amount of isotonic solution directly to one or more wells of the centrifuge vial insert or into the centrifuge vial, wherein the isotonic solution is configured to protect the cells from damage during the separation process; and flushing cells from the biological specimen through the openings such that the cells are collected in the centrifuge vial.

25. The method of claim 24, wherein the biological sample comprises bone and the bone was cut to expose bone marrow located therein.

26. (canceled)

27. (canceled)

28. (canceled)

29. (canceled)

30. (canceled)

31. A kit comprising a centrifuge vial and a centrifuge vial insert of claim 1.

32.-63. (canceled)
